(19) United States
(12) Patent Application Publication
(10) Pub. No.: US 2025/0189228 A1
(43) Pub. Date: Jun. 12, 2025

(54) FIRING SYSTEM

(71) Applicants: NGK INSULATORS, LTD., Nagoya-Shi (JP); NGK KILNTECH, CORPORATION, Nagoya-Shi (JP)

(72) Inventors: Terukazu IWATA, Nagoya-Shi (JP); Hiroaki ITO, Nagoya-Shi (JP)

(73) Assignees: NGK INSULATORS, LTD., Nagoya-Shi (JP); NGK KILNTECH, CORPORATION, Nagoya-Shi (JP)

(21) Appl. No.: 18/971,224

(22) Filed: Dec. 6, 2024

(30) Foreign Application Priority Data
Dec. 11, 2023 (JP) 2023-208811

(51) Int. Cl. F27B 9/02; F27D 5/00

(52) U.S. Cl. CPC F27B 9/02; F27D 5/0012

(57) ABSTRACT

A firing system may include: a plurality of furnaces each configured to fire a treatment object in a saggar, each of the plurality of furnaces having an entrance through which the saggar is conveyed into the furnace and an exit through which the saggar is conveyed out of the furnace; and a recovery unit configured to recover the treatment object fired by each of the plurality of furnaces. One recovery unit is arranged for the plurality of furnaces.

### REFERENCE TO RELATED APPLICATIONS

This application claims priority from Japanese Patent Application No. 2023-208811 filed on Dec. 11, 2023. The entire content of the priority application is incorporated herein by reference.

### TECHNICAL FIELD

The disclosure herein relates to a firing system.

### BACKGROUND ART

Japanese Patent No. 7041300 describes a firing system. The firing system includes a furnace and a circulation line. The furnace is configured to fire a treatment object in a firing container. The furnace has an entrance through which the firing container is conveyed into the furnace and an exit through which the firing container is conveyed out of the furnace. The circulation line is connected to the entrance and the exit of the furnace and transports the firing container conveyed out from the exit to the entrance of the furnace. The circulation line also includes a recovery unit configured to recover the treatment object from the firing container.

In the above-mentioned firing system, one circulation line with the recovery unit is installed for one furnace. Due to this, if the firing system includes a plurality of furnaces, a plurality of circulation lines would be required, with each circulation line including a recovery unit. In this configuration, a large installation space for installing the firing system would be required.

### SUMMARY

The present teachings disclose an art configured to allow an installation space for installing a firing system to be smaller.

In a first aspect of the art disclosed herein, a tiring system may comprise: a plurality of furnaces each configured to fire a treatment object in a saggar, each of the plurality of furnaces having an entrance through which the saggar is conveyed into the furnace and an exit through which the saggar is conveyed out of the furnace; and a recovery unit configured to recover the treatment object fired by each of the plurality of furnaces.

According to the above configuration, one recovery unit is installed for the plurality of furnaces. Due to this, the recovery unit configured to recover the treatment objects fired by the plurality of furnaces is arranged in a particular installation space in a consolidated manner. Due to this, as compared to when recovery units are installed for respective furnaces, an installation space for installing the firing system can be made smaller.

### BRIEF DESCRIPTION OF DRAWINGS

FIG. 1 illustrates a schematic view of a firing system according to an embodiment.

FIG. 2 illustrates a cross-sectional view of furnaces and a firing system in proximity to the furnaces in the embodiment.

### DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved firing systems, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Some of the features characteristic to below-described embodiments will herein be listed. It should be noted that the respective technical elements are independent of one another, and are useful solely or in combinations. The combinations thereof are not limited to those described in the claims as originally filed.

In a second aspect of the art disclosed herein according to the above-mentioned first aspect, the recovery unit may be separated apart from each of the plurality of furnaces, and the firing system may further comprise a first automatic transport device configured to automatically move and transport the saggar conveyed out from each of the exits of the plurality of furnaces to the recovery unit. According to the above configuration, the saggar(s) conveyed out of the respective exits of the plurality of furnaces can be easily transported to the recovery unit.

In a third aspect of the art disclosed herein according to the above-mentioned first or second aspects, the firing system may further comprise: a supply unit separated apart from each of the plurality of furnaces and configured to supply an unfired treatment object to a saggar; and a second automatic transport device configured to automatically move and transport the saggar supplied with the unfired treatment object to the entrance of one of the plurality of furnaces. According to the above configuration, the saggar(s) can be easily transported from the supply unit to the entrance of each of the plurality of furnaces.

### Embodiment

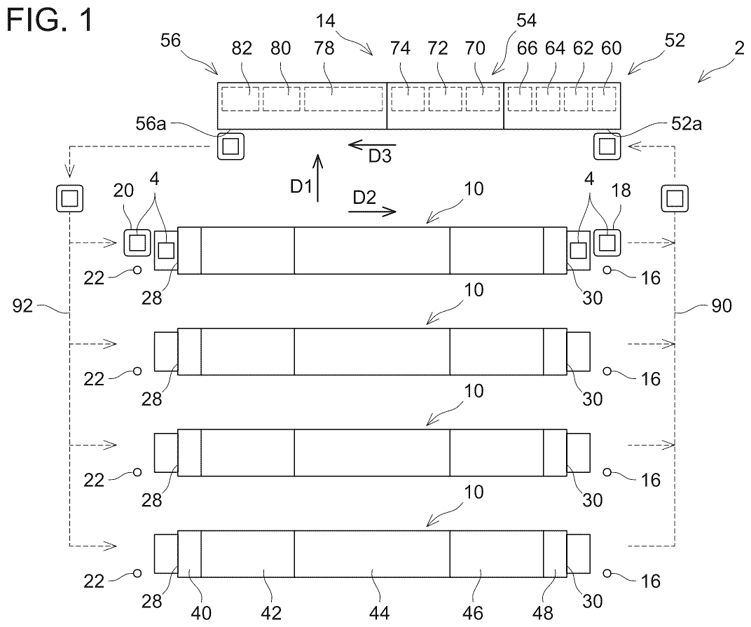

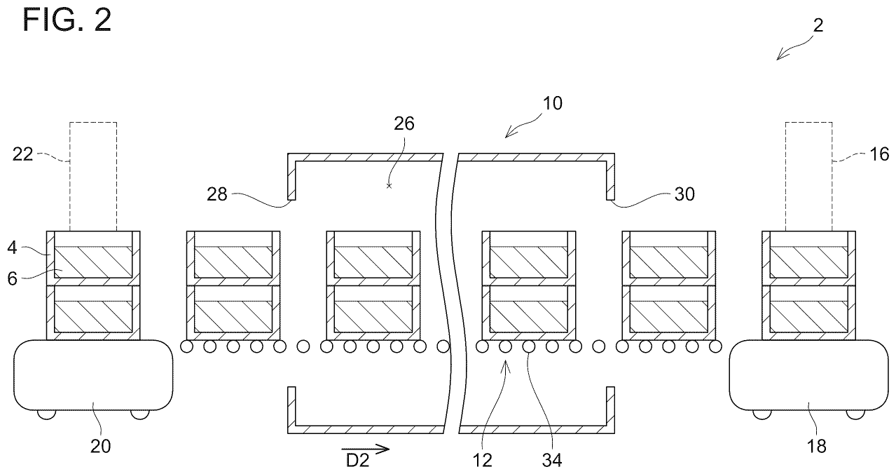

As illustrated in FIG. 1, a firing system 2 comprises a plurality of furnaces 10, a transport unit 12 (see FIG. 2), a recover and supply unit 14, a plurality of exit robots 16, a plurality of first automatic transport devices 18, a plurality of second automatic transport devices 20, and a plurality of entrance robots 22.

The plurality of furnaces 10 is aligned in a column direction D1. The column direction D1 is perpendicular to a longitudinal direction D2 of the furnaces 10. As illustrated in FIG. 2, each of the furnaces 10 fires treatment objects 6 in saggars 4. Each saggar 4 has a box shape with an open top end. The treatment objects 6 are for example a material for ceramic capacitor, or a positive material and a negative material of a lithium-ion battery.

Each furnace 10 is a thermally insulated structure with a substantially cuboid shape. Each furnace 10 has an internal space 26 therein. Also, each furnace 10 has an entrance 28 arranged at one end of the furnace 10 and an exit 30 arranged at another end of the furnace 10. The internal space 26 communicates with the outside of the furnace 10 through each of the entrance 28 and the exit 30.

The transport unit 12 comprises a plurality of rollers 34 having both ends rotatably supported. The plurality of rollers 34 is disposed by striding across the internal space 26 and the outside of the furnace 10. The plurality of saggars 4 is placed on the rollers 34 in a stacked state. When the rollers 34 rotate, the plurality of saggars 4 is conveyed through the entrance 28 into the internal space 26. Next, the plurality of saggars 4 is moved by the rotation of the rollers 34 in the internal space 26 from the entrance 28 to the exit 30 in a conveying direction D2. When the plurality of saggars 4 has moved to the exit 30, the saggars 4 are conveyed by the rotation of the rollers 34 through the exit 30 to the outside of the furnace 10. In the present embodiment, the conveying direction D2 corresponds to the longitudinal direction D2 of each furnace 10 and is substantially perpendicular to the column direction D1.

As illustrated in FIG. 1, each furnace 10 comprises a first substitution unit 40, a preheat unit 42, a firing unit 44, a cooling unit 46, and a second substitution unit 48. The first substitution unit 40, the preheat unit 42, the firing unit 44, the cooling unit 46, and the second substitution unit 48 are sequentially aligned in the conveying direction D2. Due to this, the entrance 28 is disposed in the first substitution unit 40, and the exit 30 is disposed in the second substitution unit 48. The saggars 4 move sequentially in the first substitution unit 40, the preheat unit 42, the firing unit 44, the cooling unit 46, and the second substitution unit 48.

The first substitution unit 40 substitutes gas at and around the entrance 28 of the internal space 26 from air to suitable atmospheric gas. The atmospheric gas is for example nitrogen gas or oxygen gas. The preheat unit 42 preheats the treatment objects 6 in the saggars 4 (see FIG. 2). The firing unit 44 fires the treatment objects 6 in the saggars 4. A temperature of the firing unit 44 is higher than a temperature of the preheat unit 42. The cooling unit 46 cools the treatment objects 6 in the saggars 4 at and around an exit of the cooling unit 46. A temperature at and around the exit of the cooling unit 46 is lower than both the temperature of the preheat unit 42 and the temperature of the firing unit 44. The second substitution unit 48 substitutes gas at and around the exit 30 of the internal space 26 from the atmospheric gas to air.

In the present embodiment, a plurality of circulation lines is not installed for the plurality of furnaces 10, but a single recover and supply unit 14 is installed for the plurality of furnaces 10. Due to this, an installation space for installing the firing system 2 can be made smaller. The recover and supply unit 14 comprises one first recovery unit 52, one second recovery unit 54, and one supply unit 56. The first recovery unit 52, the second recovery unit 54, and the supply unit 56 are sequentially aligned in a direction D3 opposite from the conveying direction D2. The first recovery unit 52, the second recovery unit 54, and the supply unit 56 are aligned in one line. The first recovery unit 52, the second recovery unit 54, and the supply unit 56 are integrated. That is, in the present embodiment, the first recovery unit 52, the second recovery unit 54, and the supply unit 56 are disposed at a particular installation space in a concentrated manner.

In the present embodiment, the first recovery unit 52 is a first recovery station which treats the saggars 4 conveyed out of the plurality of furnaces 10. The first recovery unit 52 is disposed apart from each of the plurality of furnaces 10. The first recovery unit 52 has an entrance 52a through which the saggars 4 are conveyed therein. The first recovery unit 52 comprises an unstacking unit 60, a first mill unit 62, an invert and recovery unit 64, and a cooling unit 66.

The unstacking unit 60 unstacks the stacked saggars 4. The first mill unit 62 roughly crushes the treatment object 6 by piercing the fired treatment object 6 in each saggar 4 with pin(s). The invert and recovery unit 64 inverts the saggar 4 filled with the crushed treatment object 6 upside down. Due to this, the fired treatment object 6 in the saggar 4 is recovered by a recovery container. That is, the recovery container is arranged below the invert and recovery unit 64 and the saggar 4 is inverted upside down, by which the fired treatment object 6 drops down into the recovery container, and accordingly collected therein. The saggar 4 from which the fired treatment object 6 was recovered passes through the second recovery unit 54, and is sent to the supply unit 56. The cooling unit 66 is arranged below (or above) a transport passage which transports the saggar 4 from which the fired treatment object 6 was recovered, and cools the recovered treatment object 6 recovered in the recovery container.

In the present embodiment, the second recovery unit 54 is a second recovery station which treats the treatment object 6 which was recovered in the recovery container by the first recovery unit 52 (the first recovery station). The second recovery unit 54 is disposed apart from each of the plurality of furnaces 10. The second recovery unit $4 comprises a transport unit 70, a second mill unit 72, and a storage unit 74. The transport unit 70, the second mill unit 72, and the storage unit 74 are disposed below (or above) the transport passage which transports the saggar 4 from which the fired treatment object 6 was recovered (i.e., passage which transports the saggar 4 from the invert and recovery unit 64 to the supply unit 56).

The transport unit 70 transports the recovery container into which the treatment object 6 was recovered. The second mill unit 72 crushes the treatment object 6 recovered in the recovery container with a roll crusher into fine pieces. The storage unit 74 stores the treatment object 6 crushed by the second mill unit 72.

In the present embodiment, the supply unit 56 is a supply station which supplies a treatment object 6 before being fired (unfired treatment object 6) to the saggar 4 conveyed from the first recovery unit 52 (the first recovery station). The supply unit 56 is disposed apart from each of the plurality of furnaces 10. The supply unit 56 comprises a treatment object supply unit 78, a leveling unit 80, and a stacking unit 82.

The treatment object supply unit 78 supplies the unfired treatment object 6 to the saggar 4 from which the fired treatment object 6 was recovered. The leveling unit 80 levels a surface of the treatment object 6 in the saggar 4. The stacking unit 82 stacks the plurality of saggars 4 vertically. The plurality of saggars 4 is conveyed out of an exit 56a of the supply unit 56 in the vertically-stacked state. Each exit robot 16 is arranged in proximity to the exit 30 of the corresponding furnace 10. Each exit robot 16 is arranged outside the furnace 10. One exit robot 16 is arranged for one furnace 10. Due to this, the number of the plurality of the exit robots 16 is equal to the number of the plurality of furnaces 10. As illustrated in FIG. 2, each exit robot 16 moves the saggar(s) 4 conveyed out of the exit 30 of the furnace 10 to the first automatic transport device 18 by using for example an arm.

In the present embodiment, the first automatic transport device 18 is an automated guided vehicle (AGV) configured to automatically move along a predetermined path. In a modification, the first automatic transport devices 18 may be autonomous mobile robots (AMR) configured to move autonomously. Each first automatic transport device 18 is configured to carry the saggar(s) 4 thereon. The plurality of saggars 4 is carried on the first automatic transport device 18 in the stacked state.

As illustrated in FIG. 1, each first automatic transport device 18 is configured to move on a first passage 90 between the exit 30 of each furnace 10 and the entrance 52a of the first recovery unit 52. Due to this, there is no need for installing a circulation line which connects the exit 30 of each furnace 10 and the entrance 52a of the first recovery unit 52. Each first automatic transport device 18 with the plurality of saggars 4 stacked thereon moves on the first passage 90 from the exit 30 of the furnace 10 to the entrance 52a of the first recovery unit 52. Due to this, the saggars 4 and the fired treatment objects 6 are transported by each first automatic transport device 18 from the exit 30 of the furnace 10 to the entrance 52a of the first recovery unit 52. Next, the plurality of saggars 4 on each first automatic transport device 18 is conveyed from the entrance 52a into the first recovery unit 52. Each first automatic transport device 18 after having conveyed the saggars 4 moves on the first passage 90 from the entrance 52a of the first recovery unit 52 to the exit 30 of the furnace 10. Here, in FIG. 1, the first passage 90 is shown in broken lines. In the firing system 2 of the present embodiment, the plurality of first automatic transport devices 18 is set up, and conveys the saggars 4 from each furnace 10 to the first recovery unit 52. Because for each of the plurality of furnaces 10 a distance from the furnace 10 to the first recovery unit 52 varies, a relatively larger number of the first automatic transport devices 18 is assigned for the furnace 10 with a longer distance to the first recovery unit 52. For which furnace 10 among the plurality of furnaces 10 one or more of the first automatic transport devices 18 are assigned is determined by a management device depending on operation conditions of the respective furnaces 10. The management device is not illustrated.

In the present embodiment, each second automatic transport device 20 is an automated guided vehicle (AGV) configured to automatically move along a predetermined path. In a modification, the second automatic transport devices 20 may be autonomous mobile robots (AMR) configured to move autonomously. As illustrated in FIG. 2, each second automatic transport device 20 is configured to carry the saggar(s) 4 thereon. The plurality of saggars 4 are carried on each second automatic transport device 20 in the stacked state.

As illustrated in FIG. 1, each second automatic transport device 20 is configured to move on a second passage 92 between the exit 56a of the supply unit 56 and the entrance 28 of each furnace 10. Due to this, there is no need for installing a circulation line which connects the exit 56a of the supply unit 56 and the entrance 28 of each furnace 10. Each second automatic transport device 20 is configured to carry the plurality of saggars 4 supplied with the unfired treatment objects 6. Each second automatic transport device 20 with the plurality of saggars 4 stacked thereon moves on the second passage 92 from the exit 56a of the supply unit 56 to the entrance 28 of its assigned furnace 10. Due to this, the saggars 4 and the unfired treatment objects 6 are transported by each second automatic transport device 20 from the exit 56a of the supply unit 56 to the entrance 28 of the assigned furnace 10. Next, the plurality of saggars 4 on each second automatic transport device 20 is moved by the entrance robot 22 to the entrance 28 of the assigned furnace 10. Lastly, each second automatic transport device 20 moves on the second passage 92 from the entrance 28 of the furnace 10 to the exit 56a of the supply unit 56. Here, in FIG. 1, the second passage 92 is shown in broken lines. Similar to the first automatic transport devices 18, the plurality of second automatic transport devices 20 is set up. To which furnace 10 among the plurality of furnaces 10 one or more of second automatic transport devices 20 are to transport the saggars 4 is determined by the management device depending on operation conditions of the respective furnaces 10.

Each entrance robot 22 is arranged in proximity to the entrance 28 of its corresponding furnace 10. Each entrance robot 22 is arranged outside the furnace 10. One entrance robot 22 is provided for one furnace 10. Due to this, the number of the entrance robots 22 is equal to the number of the furnaces 10. As illustrated in FIG. 2, each entrance robot 22 moves the plurality of saggars 4 on the second automatic transport device 20 to the entrance 28 of its corresponding furnace 10 by using, for example, an arm.

### Effects

In the above embodiment, one single first recovery unit 52 is installed for the plurality of furnaces 10. Due to this, the first recovery unit 52 which recovers the treatment objects 6 fired by the plurality of furnaces 10 is disposed at a particular installation space in a consolidated manner. Due to this, as compared to a case where circulation lines are provided for the respective furnaces 10 and each circulation line includes the first recovery unit 52, an installation space for installing the firing system 2 can be made smaller.

### Correspondence Relationship

The first recovery unit 52 is an example for “recovery unit”.

### Modifications

In an embodiment, the first recovery unit 52 and the second recovery unit 54 may be separated apart, and also the second recovery unit 54 and the supply unit 56 may be separated apart. The first recovery unit 52 and the second recovery unit 54 may be separated apart, or the second recovery unit 54 and the supply unit 56 may be separated apart.

In an embodiment, the recover and supply unit 14 may not comprise the second recovery unit 54. In this configuration, the first recovery unit 52 and the supply unit 56 may be integrated, or may be separated apart from each other.

In an embodiment, the direction along which the recover and supply unit 14 extends may not be limited to the conveying direction D2, but may be for example the column direction D1, or may be a direction inclined relative to both the column direction D1 and the conveying direction D2.

In the above embodiment, the recover and supply unit 14 is disposed apart from each of the plurality of furnaces 10 in the column direction D1. In an embodiment, the recover and supply unit 14 may be separated apart from each of the plurality of furnaces 10 in a direction opposite from the column direction D1. Also, the recover and supply unit 14 may face the respective exits 30 of the plurality of furnaces 10, and be separated apart from the respective exits 30 in the conveying direction D2. Also, the recover and supply unit 14 may face the respective entrances 28 of the plurality of furnaces 10, and be separated apart from the respective entrances 28 in the direction D3.

In an embodiment, the transport unit 12 may not be limited to a roller transport system, but may be a pusher transport system.

In an embodiment, the plurality of saggars 4 on each first automatic transport device 18 may be conveyed through the entrance 52a into the first recovery unit 52, by using a robot. Likewise, the plurality of saggars 4 conveyed out of the exit 56a of the supply unit 56 may be mounted on each second automatic transport device 20 by using a robot.

In an embodiment, the first recovery unit 52 may further comprise a cooling unit configured to cool the saggars 4 conveyed through the entrance 52a into the first recovery unit 52. Due to this, the saggars 4 and the fired treatment objects 6 are cooled at the same time.

In an embodiment, the treatment object 6 in each saggar 4 may be recovered by the recovery container. by the saggar(s) 4 being inverted upside down after being conveyed out of the exit 30 of each furnace 10. The recovery containers may be transported by an automatic transport device to the entrance 52a of the first recovery unit 52. Also, the saggars 4 from which the treatment objects 6 were recovered may be transported by the first automatic transport devices 18 to the supply unit 56.

In an embodiment, the recover and supply unit 14 may comprise a plurality of lines in which the saggars 4 pass. The number of the plurality of lines may be smaller than the number of the plurality of furnaces 10, or may be equal to the number of the plurality of furnaces 10. In this configuration, the first recovery unit 52 may comprise, instead of the unstacking unit 60, the first mill unit 62, the invert and recovery unit 64, and the cooling unit 66, a first lifter unit which lifts the saggars 4 upward, an invert and recovery unit which recovers the treatment objects 6 in the saggars 4 by inverting the saggars 4 upside down, and a second lifter unit which lowers the saggars 4. The first recovery unit 52 may further comprise a cooling unit which cools the saggars 4 conveyed from the entrance 52a into the first recovery unit 52. Due to this, the saggars 4 and the fired treatment objects 6 are cooled at the same time. In this configuration, the first automatic transport device(s) 18 carrying the saggars 4 thereon may move in the cooling unit, and the saggars 4 may move in the cooling unit by another transport device different from the first automatic transport devices 18. Further, the plurality of saggars 4 on each first automatic transport device 18 may be conveyed by a robot from the entrance 52a into the first recovery unit 52. Also, the plurality of saggars 4 conveyed out of the exit 56a of the supply unit 56 may be mounted on each second automatic transport device 20 by a robot.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

1. A firing system comprising:
a plurality of furnaces each configured to fire a treatment object in a saggar, each of the plurality of furnaces having an entrance through which the saggar is conveyed into the furnace and an exit through which the saggar is conveyed out of the furnace; and
a recovery unit configured to recover the treatment object fired by each of the plurality of furnaces.

2. The firing system according to claim 1, wherein the recovery unit is separated apart from each of the plurality of furnaces, and
the firing system further comprises a first automatic transport device configured to automatically move and transport the saggar conveyed out from each of the exits of the plurality of furnaces to the recovery unit.

3. The firing system according to claim 1, further comprising:
a supply unit separated apart from each of the plurality of furnaces and configured to supply an unfired treatment object to a saggar; and
a second automatic transport device configured to automatically move and transport the saggar supplied with the unfired treatment object to the entrance of one of the plurality of furnaces.

4. The firing system according to claim 2, further comprising:
a supply unit separated apart from each of the plurality of furnaces and configured to supply an unfired treatment object to a saggar; and
a second automatic transport device configured to automatically move and transport the saggar supplied with the unfired treatment object to the entrance of one of the plurality of furnaces.
